(19) United States
(12) Patent Application Publication
(10) Pub. No.: US 2007/0112778 A1
(43) Pub. Date: May 17, 2007

(54) Scientific information systems and methods for global networking opportunities

(76) Inventors: Marek Graczynski, Warsaw (PL); Tomasz Wlaszczuk, Warsaw (PL)

Correspondence Address: Rashida A. Karmali, Ph.D;13th Floor, 99 Wall Street, New York, NY, 10005, US

(21) Appl. No.: 11/274,592

(22) Filed: Nov. 15, 2005

(51) Int. Cl. G06F 17/30

(52) U.S. Cl. 707/10

(57) ABSTRACT

A system and method are provided to scientific communities through a web-based infrastructure of databases including a scientific community center. The scientific community center includes a plurality of servers and web pages of general scientific interest and disciplines to all registered members of the scientific community. According to another aspect the invention provides a plurality of opportunities for a member of the scientific community to interact, collaborate and participate in the scientific community center in a global and multicultural environment.

### 1. FIELD OF INVENTION

The invention relates generally to an INDEX COPERNICUS NETWORKING SERVICE™, for the scientific community world-wide. More particularly, the invention relates to systems and methods for networking and providing a web-based communication platform of essential tools to encourage free and effective exchange of scientific information between scientists located in different countries.

### 2. BACKGROUND TO THE INVENTION

Scientists and scientific institutions have developed systems, devices and methods in multi-level computer architectures which provide capabilities for accessing a variety of databases each of which contain a wide range of information sources. The magnitude of the knowledge base in different servers, anywhere from specialized databases such as the Scientific Citation Index to the giant ones such as Google has created unlimited information and knowledge resources. Today, the rise of the technology driven economies has made information and knowledge the most useful resources. The current databases of the technology-era have several flaws that become apparent in the context of the information based scientific environment.

In the information based scientific environment, the need for effective exchange of information between scientists worldwide is increasing. Scientists are under increasing pressure to demonstrate up-to-date expertise in rapidly developing global technologies. Currently available information and knowledge models do not adequately provide a platform of essential tools for the practical implementation of up-to-date forms of information integration required for the effective sharing of knowledge.

Advances in communications and information technology have created new opportunities for organizations to build and manage virtual teams in the business world. Such teams are composed of employees with unique skills, located at a distance from each other, who must collaborate to accomplish important organizational tasks. Virtual teams allow organizations to combine the best expertise regardless of geographic location. Working virtually can reduce team process losses associated with stereotyping, personality conflicts, powers and politics commonly experienced by face-to-face teams. Diversity research shows that visual cues such as race/ethnicity and gender can decrease team integration and performance in highly diverse teams. In fact, electronic collaboration generates more minority participation in the business sector.

In the scientific fields, virtual working is usually limited to an institutional level. There is hardly any exchange of information or interaction between scientists from different countries unless there is an established relationship between the scientists from diverse and cross-cultural scientific institutions. An information-based scientific system that utilizes a web-based communication platform to provide lifelong documentation of scientific and profession achievements of the scientific communities world-wide and promote exchange of information and collaboration between the scientists would be useful. The INDEX COPERNICUS NETWORKING SERVICE™ provides such a web-based communication platform to promote effective exchange of real-life information between the scientific communities world-wide.

### 3. SUMMARY OF THE INVENTION

The present invention provides improved capabilities for scientific information and knowledge and other content in an electronic use operating environment such as a computer network containing a registration server, a plurality of content servers or databases connected to the registration server, and a plurality of member work-stations connected to the content servers. After a member registers with the registration server and requests access to a content server, the content server authenticates the request and serves the content to the member workstation. Content may be moved by the system between content servers in response to actual or anticipated member requests.

In the first aspect of the invention, a web-based system and method is provided to include databases containing information on Scientists, Journals, Case Reports Register, Patents, Grants, Research Programs, Scientific Institutions, Drug Register, Clinical Trial Register, Therapeutics Directory, Employment Register among others.

According to one aspect of the present invention, the infrastructure of web pages provides the INDEX COPERNICUS Scientific Community Center. Specifically, the community center, the INDEX COPERNICUS SCIENTISTS NETWORKING SERVICE™, comprises a plurality of web pages of general interests to all scientists in the information and knowledge community.

According to another aspect of the present invention, the customized design of web pages provides a plurality of discipline specific knowledge scientific communities. Each of the discipline specific knowledge scientific communities comprises a plurality of web pages of specific interest to members of the knowledge scientific community in targeted disciplines.

According to yet another aspect of the present invention, the design of web pages provides a plurality of opportunities for a member of the scientific community to participate in development of the knowledge community in different cultures and in different global environments. The plurality of opportunities comprises a plurality of web pages designed in the INDEX COPERNICUS Networking System through which the user may initiate activities.

The system and method of the invention are adapted to improve the accuracy and efficacy of the networking process on a real-time or near real-time basis, to enable tailoring the needs and requirements of individual scientific institutions in different countries and/or multicultural environments.

A principal object of the invention is to provide an effective system for registering users such as scientific institutions, universities, industry, publishers, libraries, students or administrators, among others, to enable accessing of different databases and networking services offered by the INDEX COPERNICUS System. The scientific databases offered include, but are not limited to, journals, scientists, ongoing research articles, clinical trials, case reports, patents, grants, funding opportunities, business organizations, job postings, medical consultants, therapeutics directories, professional or career development.

Another object of the present invention is to provide a networking service designed to enable member scientific institutions to customize the networking system and method for internal use, according to needs, culture and traditions.

The INDEX COPERNICUS databases provide system security through use of passwords issued at time of registration. The Networking features create a global virtual center for scientific communities regardless of geographical location.

These and other objects of the invention will become more clear from the following detailed description of the preferred embodiments, particularly when read in conjunction with the drawings which form a part of the specification.

In the first aspect of the present invention, a computer based system is provided for evaluating performance of scientific institutions, universities, industry, publishers, libraries, students or administrators, among others, their personnel and their work products including, but not limited to, scientific publications, research programs, grants, courses offered, and others. The system and method include the steps of registering a member, making available to the member user a first set of electronic forms consisting of specific questions for collecting in depth and standardized data for evaluation, in putting the first set of data into electronic form into INDEX COPERNICUS's evaluation data base, evaluating the first set of data to generate results in the form of scores for specific categories of information and storing said scores generated in INDEX COPERNICUS's reports database.

In another aspect of the present invention the system and method are adapted to improve the accuracy and efficacy of the evaluation process on a real-time or near real-time basis.

In yet another aspect of the present invention the system and method provide an evaluation methodology and data structure designed to enable tailoring to the needs and requirements of an individual institution, country or culture.

A principal object of the present invention is to provide an effective system for registering users such as scientific institutions, universities, industry, publishers, libraries, students or administrators, among others, collecting evaluation data, evaluating and processing said data and storing the processed data for reporting.

Another object of the present invention is to provide a system for evaluating data collected, using an evaluation system established to improve the accuracy and efficacy of the evaluation process on a real-time or near real-time basis. Data collected for evaluation comprises data in different scientific fields including, but not limited to, journals, news articles, scientists, ongoing research projects, clinical trials, case reports, patents, grants, funding opportunities, business organizations, job postings, medical consultants, therapeutics directory, professional or career development, seminars, workshops and conferences.

Another object of the present invention is to provide an evaluation methodology and data structure designed to apply standardized scoring on a uniform, global basis for all scientific institutions, universities, industry, publishers, libraries, students or administrators, among others, their personnel and their work products including, but not limited to, scientific publications, research programs, grants, courses offered, and others.

Another object of the present invention is to provide an evaluation methodology and data structure designed to apply to enable tailoring the INDEX COPERNICUS evaluation system to an individual institution.

Another object of the present invention is to provide an evaluation methodology and data structure designed to apply standardized scoring on a country basis for all scientific institutions, universities, industry, publishers, libraries, students or administrators, among others, their personnel and their work products including, but not limited to scientific publications, research programs, grants, courses offered, and others.

Another object of the present invention is to provide an evaluation methodology and data structure designed to enable member institutions to customize the scoring system for internal use, according to needs, culture and traditions by selecting specific parameters to generate individual category and cumulative scores for internal monitoring and evaluation.

Still another object of the present invention is to provide a system that produces timely performance reports that are capable of delivering evaluation scores for overall performance as well as for particular areas of performance.

Another object of the present invention is to provide system security and controlled access to data in INDEX COPERNICUS databases through use of passwords.

These and other objects of the present invention will become clear from the following detailed description of the preferred embodiments, particularly when read in conjunction with the drawings which form a part of the specification.

### 4. BRIEF DESCRIPTION OF THE DRAWINGS

For a fuller understanding of the invention, reference is made to the following description, taken in connection with the accompanying drawings, in which:

FIG. 1 is a flow diagram that shows the login by a new user into the INDEX COPERNICUS System. The next step is for the user to enter the Registration Page and enter information such as a) First Name and Last Name, b) correspondence address, c) telephone and fax numbers and e-mail address, and d) specialty of professional training. The users of the INDEX COPERNICUS Networking Services include publishers, libraries, students, scientists, professionals, universities, scientific institutions, industry or administration among others. The INDEX COPERNICUS Home Page may be linked to an individual User's Home Page, an Institutional User's Home Page or Corporate User's Home Page.

FIG. 2 is a flow diagram showing a plurality of databases that are accessible by using the INDEX COPERNICUS system, and groups of web pages for Literature search, search for scientists or search for authors for providing networking services to members of a scientific community according to one embodiment of the invention.

FIG. 3 is a flow diagram illustrating an exemplary webpage over which scientists may use the Networking Services of INDEX COPERNICUS through the Journals Mast list database.

FIG. 4 is a flow diagram illustrating a web page for networking services to members of a scientific community through accessing the database for scientists.

FIG. 5 is a flow diagram illustrating a webpage for networking services according to the embodiment for accessing the Grants database.

FIG. 6 is a flow diagram illustrating an embodiment in which scientists use the networking services by accessing the database for patents.

FIG. 7 is a flow diagram illustrating an embodiment in which scientists use the networking services by accessing the database for Case Reports.

FIG. 8 is a flow diagram illustrating an embodiment in which scientists use the networking services by accessing the database for Laboratory and Clinical Trials.

FIG. 9 is a flow diagram illustrating an embodiment in which scientists use the networking services by accessing the database for Research Proposals.

FIG. 10 is a flow diagram illustrating an embodiment in which scientists use the networking services by accessing the database for Case Reports.

FIG. 11 is a flow diagram illustrating an embodiment in which scientists use the networking services by accessing the database for Jobs and Positions available.

FIG. 12 is a flow diagram illustrating an embodiment in which scientists use the networking services by accessing the database for Medical Problems.

FIG. 13 is a flow diagram illustrating an embodiment in which scientists use the networking services by accessing the database for Therapeutics.

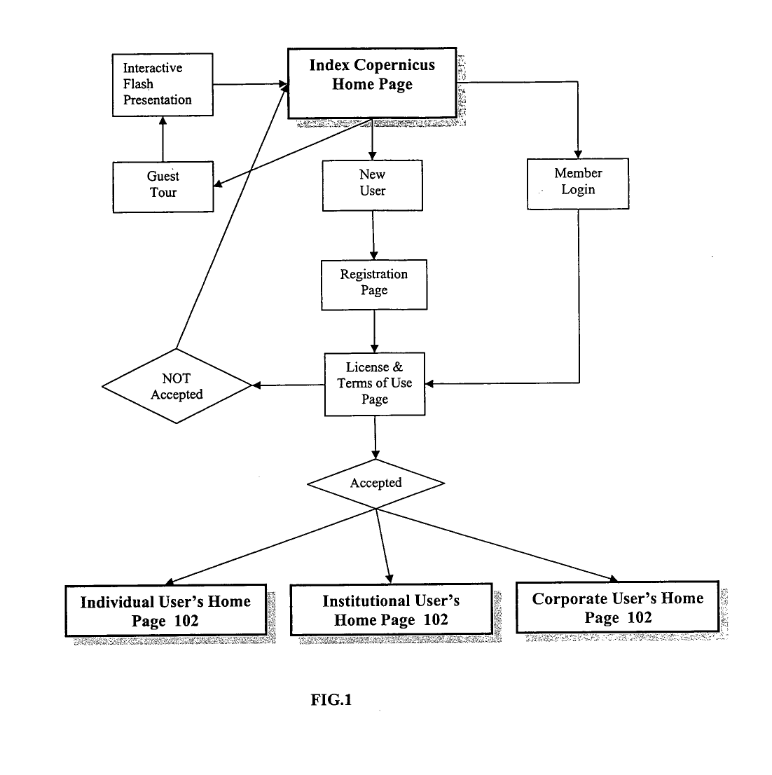

### 5. DETAILED DESCRIPTION OF THE INVENTION

A computer based system and method provided for networking by scientists, scientific institutions, universities, industry, publishers, libraries, students or administrators, among others. The present invention relates to systems and methods provided in a multi-level computer architecture of an electronic virtual operating environment including a registration server (100), a plurality of content servers or databases connected to the registration server (101), a plurality of member work-stations connected to the content servers (102). The registration server 101 includes a remote registration manager and registration database for new user registration, and that each registration server 102 is free of any deliverable content that is managed by the architecture of content servers 101. The next level of the content servers 103 are the plurality of databases for content on Patents, grants, case reports or laboratory and clinical trials. Each content server 103 has a network connection to the registration server 100. Each network may involve a dedicated link, a virtual circuit or one or more types of network communication links to those skilled in the art or to the member scientists. Each content server 103 serves the managed content for presentation to the member users, that is, users who have previously been registered with the registration server 101. The registration provides member users with a unique user name and it may also coordinate a password or manage access control. In a co-pending application, U.S. Ser. No. 11/216,663, filed Aug. 31, 2005, is described the system and method of evaluating scientific information into and compiling the content servers, which is incorporated herein in its entirety.

Other suitable content-server member networks may contain peer-to-peer nodes which perform as content servers. The computers connected to the INDEX COPERNICUS network may be workstations, laptop computers, mobile computers, mainframes, or a combination thereof. The network may include communications or networking software such as software available from Novell, Microsoft, Arti Soft, SCO and other vendors, and may operate using TCP/IP, SPX, IPX, and other protocols over connections that include twisted pair, coaxial, or optic fiber cables, telephone lines, and/or other transmissions wires known to those of skill in the art.

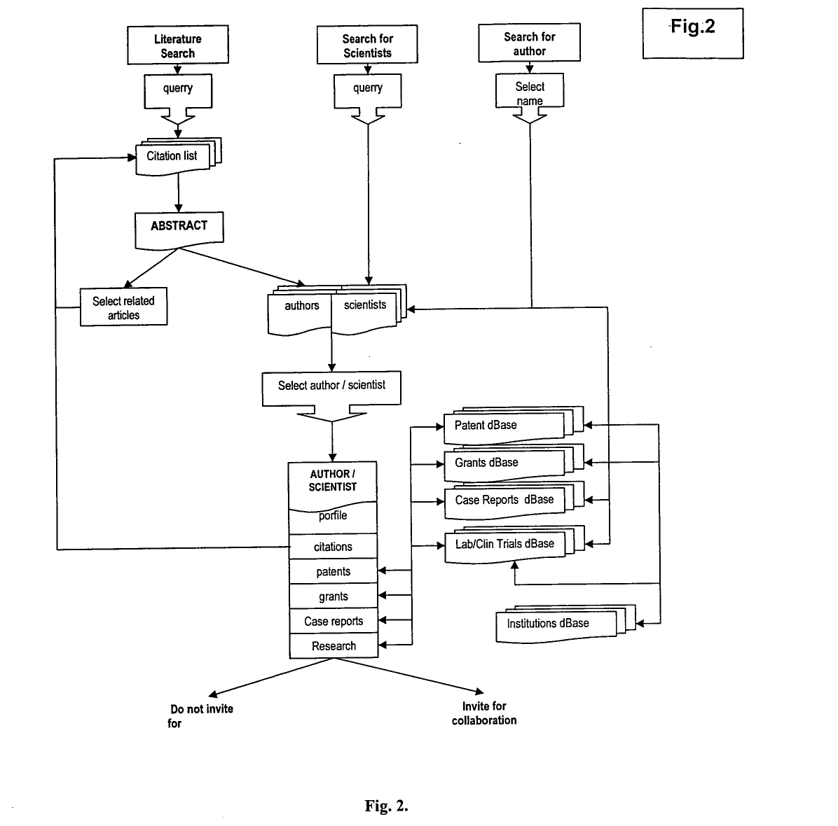

FIG. 2 illustrates an embodiment of the invention in which a registered member is searching for a scientific collaborator. The member user uses the networking system of INDEX COPERNICUS to access content servers containing information on scientific literature published by a potential collaborator.

Using the INDEX COPERNICUS servers containing information on scientists and authors, a member user can select a scientific collaborator based on the information provided by the INDEX COPERNICUS networking system. Additional databases offered by the INDEX COPERNICUS networking system include the grants database, the patents database, the case reports database, the lab and clinical trials database, jobs database, medical problems database, therapeutics database and others.

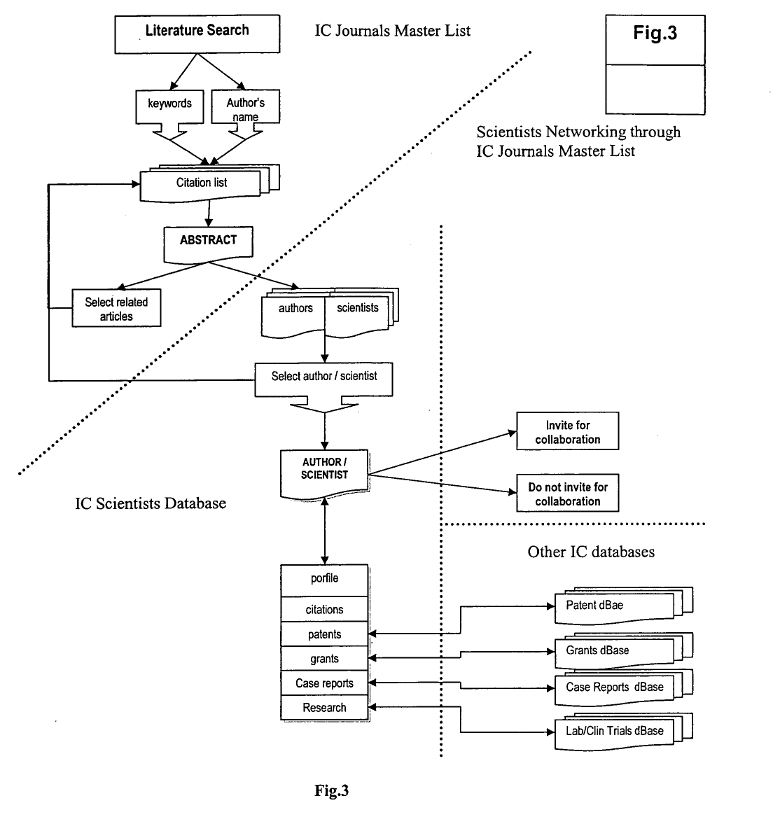

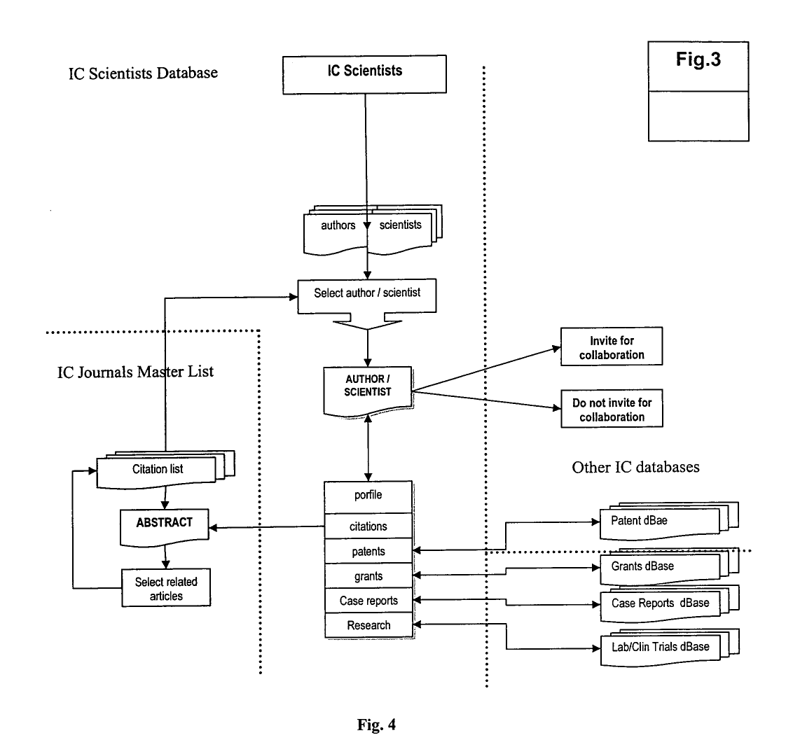

FIG. 3 describes the INDEX COPERNICUS networking system for the journals database in the form of a flow diagram in which the member user carries out the following tasks after logging into the INDEX COPERNICUS networking system:

[1] Scientists browse literature collected in IC Journal Master List dBase, by authors name, subject keywords or journal issues

[2] citation list is displayed

[3] from the single abstract level or citation list, authors names are displayed

[4] clicking on the name, the full authors profile stored in IC Scientists dBase can be displayed

[5] all other relevant information stored in other IC databases like patents, grants, case reports etc. can be displayed for particular author

[6] contact information provided in scientists profile enable contact with selected author/scientist

FIG. 4 describes the INDEX COPERNICUS networking system for the scientists database in the form of a flow diagram in which the member user carries out the following tasks after logging into the INDEX COPERNICUS networking system:

[1] Scientists browse information collected in IC Scientists dBase, by name, geographical location, specialty or subject keywords

[2] selected name list is displayed

[3] clicking on the name, the full scientist's profile stored in IC Scientists dBase can be displayed

[4] all other relevant information stored in other IC databases like patents, grants, case reports etc. can be displayed for particular author

[5] contact information provided in scientists profile enable contact with selected author/scientist

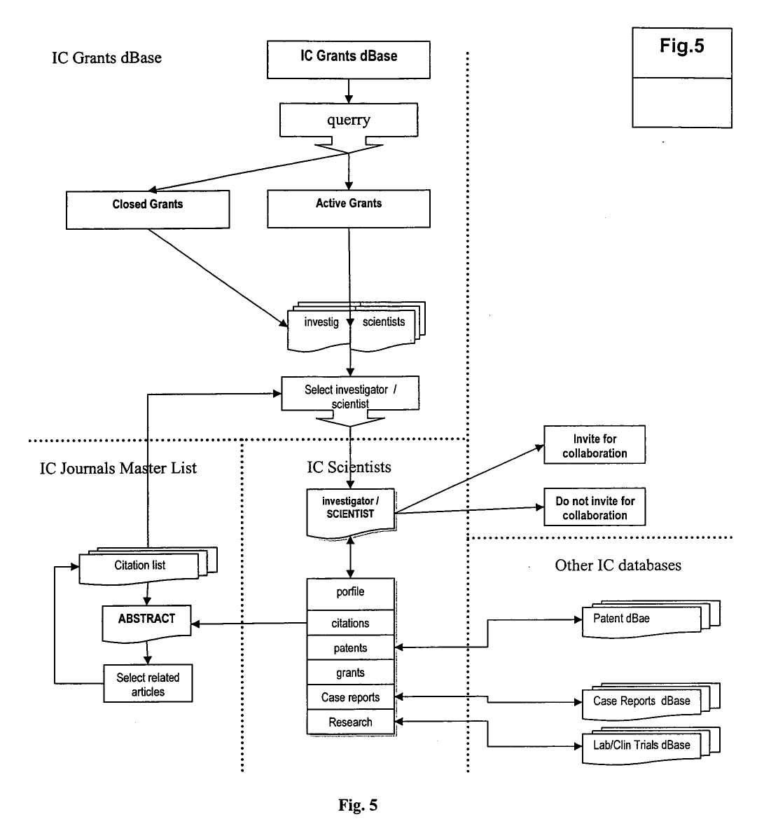

FIG. 5 describes the INDEX COPERNICUS networking system for the Grants database in the form of a flow diagram in which the member user carries out the following tasks after logging into the INDEX COPERNICUS networking system:

[1] Scientists browse grants collected in IC Grants dBase, by authors name, subject keywords

[2] selected grants list is displayed

[3] from the single abstract level or grant list, authors names are displayed

[4] clicking on the name, the full authors profile stored in IC Scientists dBase can displayed

[5] all other relevant information stored in other IC databases like patents, grants, case reports etc. can be displayed for particular author

[6] contact information provided in scientists profile enable contact with selected author/scientist

Grants and Funding opportunities can be posed by Institution or Business Organization members of Index Copernicus

The information on Funds and/or Grants available includes the following:
[1] Name of funding organization/grantor
[2] type of fundator/grantor
[3] address and contact
[4] person within the organization to contact
[5] type of grant
[6] research field
[7] specific research project title—if available/applicable
[8] grant span
[9] grant duration
[10] funds available
[11] eligibility conditions
[12] keywords for matching purposes

Scientists can access the grants/funding opportunities in three ways:
[1] by searching “Grants Opportunities” or “Funding Opportunities”
[2] through browsing information within the organization profile provided by Index Copernicus
[3] pre-screened grant/funding opportunities are automatically delivered to scientists whose profile/keywords match with the offer

Information on pending grants contain also the names of beneficents of the offer either individual scientists or institutions. The full profile information can be accessed about beneficent.

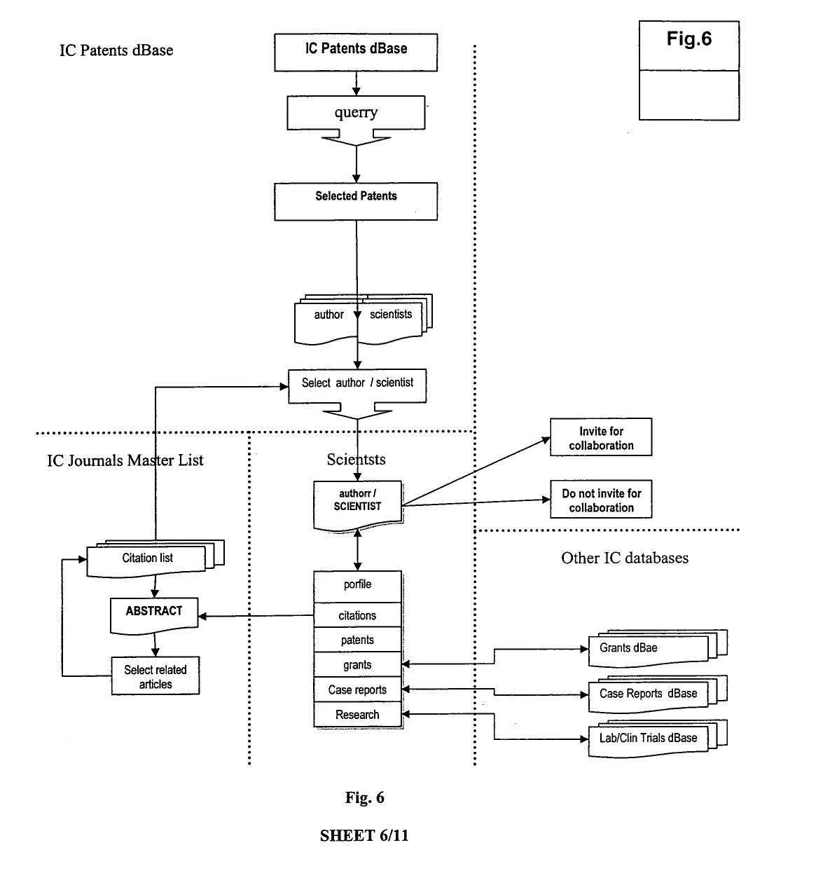

FIG. 6 describes the INDEX COPERNICUS networking system for the Patents database in the form of a flow diagram in which the member user carries out the following tasks after logging into the INDEX COPERNICUS networking system:
[1] Scientists browse patents collected in IC Patents dBase, by authors name, subject keywords
[2] selected patents list is displayed
[3] from the single abstract level or grant list, authors names are displayed
[4] clicking on the name, the full authors profile stored in IC Scientists dBase can be displayed
[5] all other relevant information stored in other IC databases like patents, grants, case reports etc. can be displayed for particular author
[6] contact information provided in scientists profile enable contact with selected author/scientist

Information on patents provided by IC Service include the following:
[1] Patent title
[2] Patent number
[3] Patent date
[4] Patent status
[5] Patent span
[6] Patent owner
[7] Contact to the patent owner
[8] Patent Attorney or Law Company who represents the Patent Owner including web address
[9] description of the patent [if available]
[10] field of science
[11] keywords

Patent Search can be accessed in two ways:
[1] by accessing the service from within the Scientists Individual HomePage
[2] by accessing patent information available on Scientist's Profile. Scientist's Profile can be accessed by a number of ways, ever time one clicks on underlined name found anywhere in the IC Services

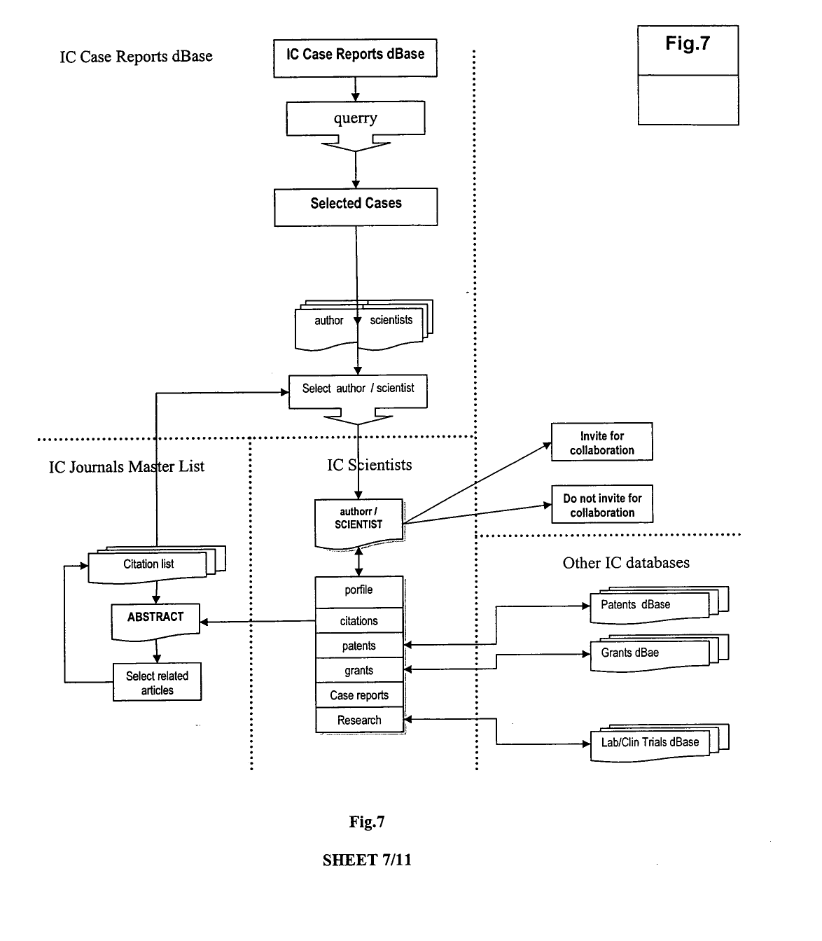

FIG. 7 describes the INDEX COPERNICUS networking system for the CASE REPORTS database in the form of a flow diagram in which the member user carries out the following tasks after logging into the INDEX COPERNICUS networking system:
[1] Scientists browse case reports collected in IC Case Reports dBase, by authors name, subject keywords
[2] selected case reports list is displayed
[3] from the single abstract level or case report list, authors names are displayed
[4] clicking on the name, the full authors profile stored in IC Scientists dBase can be displayed
[5] all other relevant information stored in other IC databases like patents, grants, case reports etc. can be displayed for particular author
[6] contact information provided in scientists profile enable contact with selected author/scientist

Case Reports Management allows users to:
[1] add single case reports,
[2] browse case reports database and
[3] set up prospective case reports studies.

Information collected on case reports includes:
[1] Category of case report:
   [a] Diseases
      rare disease
      unusual presentation of unknown etiology
      unusual natural history/clinical course
   [b] Diagnosis
      mistake in diagnosis
      challenging differential diagnosis
   [c] Treatment
      unusual or unexpected effect or treatment
      unusual setting of medical care
      management of emergency care
   [d] Complications and accidents
      procedure complications
      therapeutic complications
      malpractice/patients complains
   [e] Adverse drug reactions
      unexpected drug reaction
      adverse drug reaction
[2] Patient information
   [a] date of bright
   [b] age at diagnosis
   [c] gender
   [d] race
   [e] time from diagnosis to report
   [f] hospital id
   [g] alive or dead at time of report
[3] Case information
   [a] diagnosis date
   [b] primary diagnosis
   [c] co-existing diseases
   [d] report on clinical problem
   [e] solution of the problem
   [f] keywords
   [g] medical field/specialty

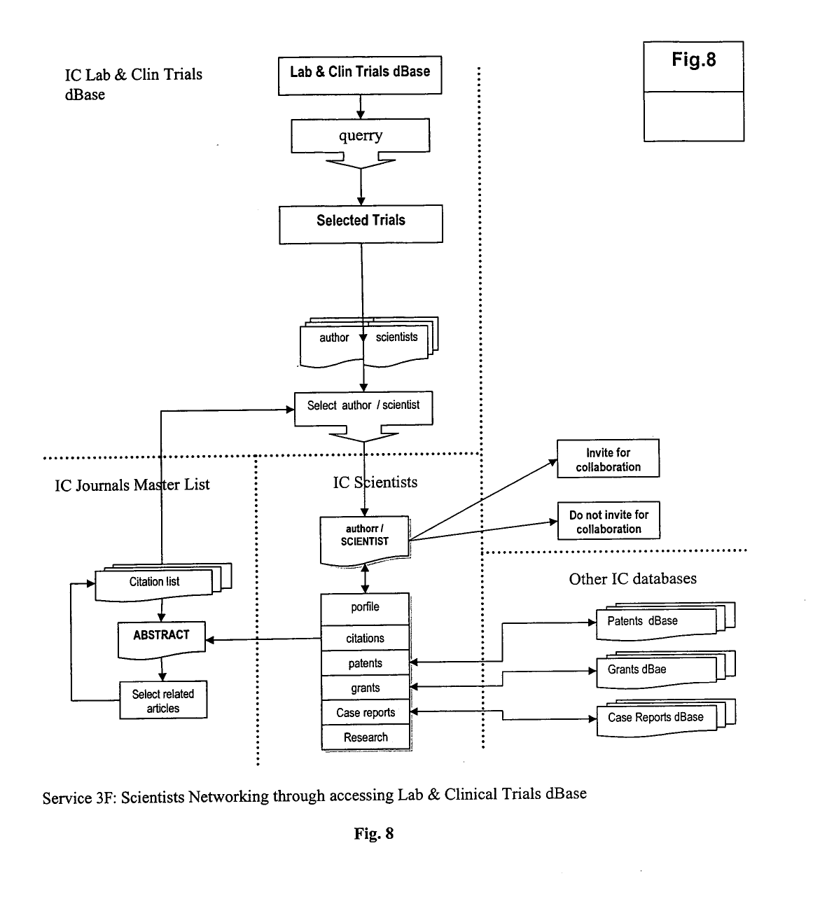

FIG. 8 describes the INDEX COPERNICUS networking system for the Lab & Clinical Trials database in the form of a flow diagram in which the member user carries out the following tasks after logging into the INDEX COPERNICUS networking system:
[1] Scientists browse ongoing research projects collect in IC Lab & Clinical Trials dBase, by authors name, subject keywords, specialty, etc.
[2] selected trial list is displayed
[3] from the single abstract level or trial list, authors names are displayed
[4] clicking on the name, the full authors profile stored in IC Scientists dBase can be displayed
[5] all other relevant information stored in other IC databases like patents, grants, case reports etc. can be displayed for particular author
[6] contact information provided in scientists profile enable contact with selected author/scientist

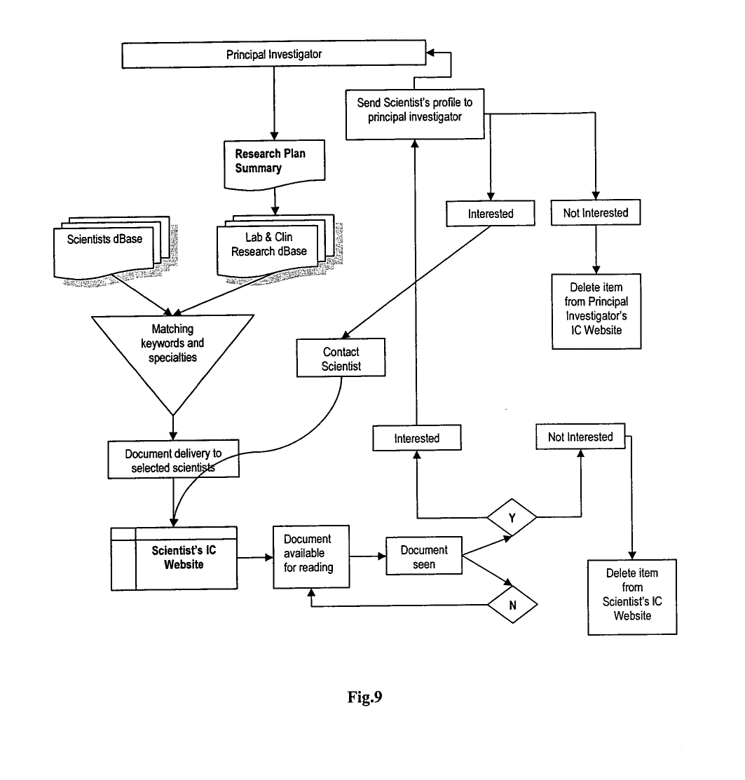

FIG. 9 describes the INDEX COPERNICUS networking system for the Collaborators database in the form of a flow diagram in which the member user carries out the following tasks after logging into the INDEX COPERNICUS networking system:
[1] Principal Investigator posts Research Summary Plan (RSP) to Lab & Clinical Trial dBase.
[2] RSP is matched with Scientists Profile keywords of scientists database.
[3] RSP is delivered to Scientists IC HomePage only of those scientists whose profile keywords matches with RSP keywords
[4] Scientists read RSP and decide if they are interested in joining the study
[4a] if they decide “not interested” the RSP document is deleted from the Scientist's IC HomePage
[4b] if they decide “interested” the Scientist's Profile is forwarded to Principal Investigator
[5] Principal Investigator reads Scientist's Profile and decides to invite/not to invite him/her to join the study
[6] If Principal Investigator decides to invite a Scientist to join the research team, he/she sends invitation to the Scientist

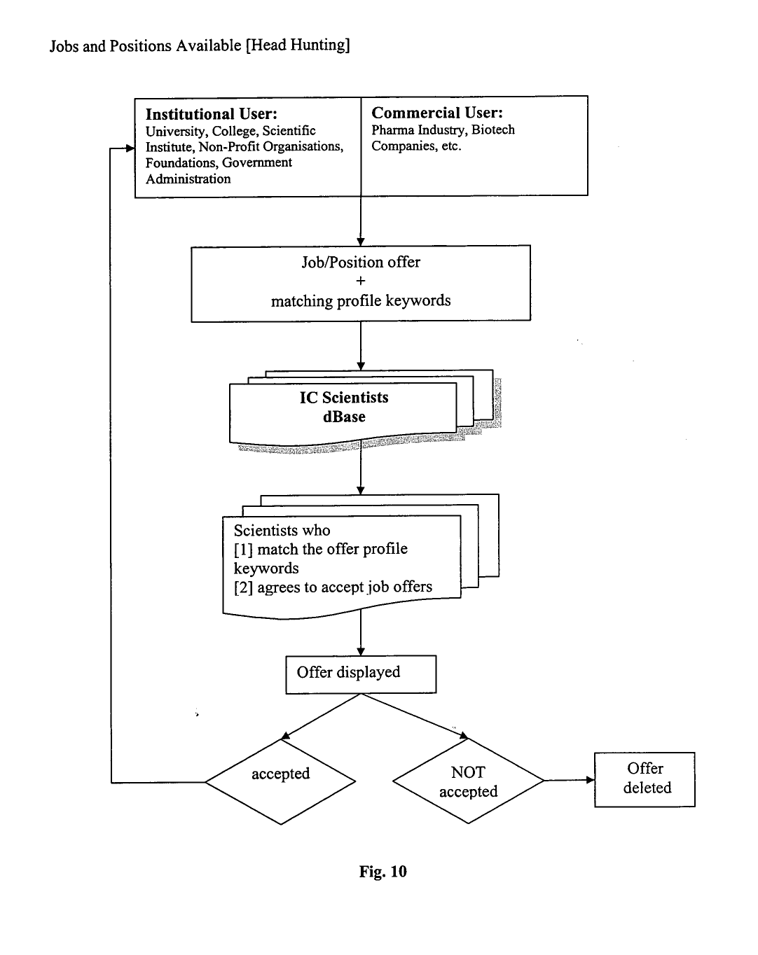

FIG. 10 describes the INDEX COPERNICUS networking system for the jobs' database in the form of a flow diagram in which the member user carries out the following tasks after logging into the INDEX COPERNICUS networking system to search for business organizations:

Business Organizations provide the following information:
[1] Organization's Name
[2] business profile [i.e. medicine, pharma, administration, commercial, manufacturer, law, etc.]
[3] address and contact
[4] contact person+position
[5] keywords

Business Organizations are allowed to provide the following information/services:
[1] to send corporate newsletter
[2] to offer research grants
[3] to offer jobs opportunities
[4] to search for investigators
[5] to display their products
[6] to offer their services

Business Organizations may be search by:
[1] Name of organization
[2] geographical localization [city, country]
[3] business profile
[4] keywords
[5] job opportunities and available grants may be search from within the organization IC webpage

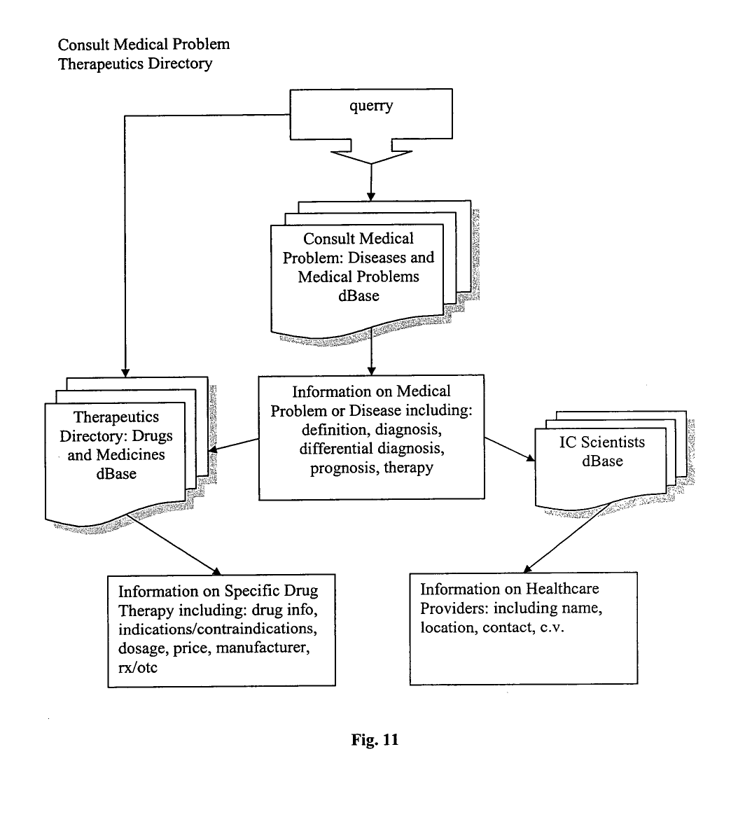

FIG. 11 describes the INDEX COPERNICUS networking system for the Medical Problems and Therapeutic Directory database in the form of a flow diagram in which the member user carries out the search for service 12 or 13 respectfully after logging into the INDEX COPERNICUS networking system.

The present invention is not to be limited in scope by the embodiment disclosed in the example which is intended as an illustration of one aspect of the invention and any methods which are functionally equivalent are within the scope of the invention. Indeed, various modifications of the invention in addition to those shown and described herein will become apparent to those skilled in the art from the foregoing description. Such modifications are intended to fall within the scope of the appended claims.

Those skilled in the art will recognize, or be able to ascertain using no more than routine experimentation, any equivalents to the specific embodiments of the invention described herein. Such equivalents are intended to be encompassed by the claims.

What is claimed is:

1. A system comprising:
a computer network, and
at least one registration server connected with the computer network, and a plurality of content servers connected to the registration server to provide networking services to members of the scientific community through the network, the content servers comprising:
a scientific community center including the infrastructure of web pages of general interest to all members of the scientific community,
a plurality of discipline specific scientific communities, each of the discipline specific scientific communities comprising a plurality of web pages of specific interest to members of the scientific community in different cultures and global environments, and
a plurality of opportunities for a member of the scientific community to participate in the scientific community center, the plurality of opportunities comprising web pages through which the member networks and interacts on a real-time basis.

2. The system of claim 1, wherein the scientific community center comprises a member center, the member center including a searchable directory of registered members, the directory accessible only by other members of the scientific community.

3. The system of claim 2, wherein the member center comprises a web page to enroll new members via an electronic enrollment form based on information provided by the new member.

4. The system of claim 1, wherein the scientific community center comprises a plurality of databases including journals, news articles, scientists, ongoing research projects, clinical trials, case reports, patents, grants, funding opportunities, business organizations, job postings, medical consultants, therapeutics directory, professional and career development, seminars, workshops or conferences.

5. The system of claim 3, wherein the scientific community center comprises a plurality of databases produced from information entered by members of the scientific community, the databases accessible only by other members of the scientific community.

6. The system of claim 1, wherein the scientific community center comprises a plurality of evaluating databases for providing accuracy in data collected in different scientific fields including journals, news articles, scientists, ongoing research projects, clinical trials, case reports, patents, grants, funding opportunities, business organizations, job postings, medical consultants, therapeutics directory, professional and career development, seminars, workshops or conferences.

7. The system of claim 1, wherein the scientific community center comprises a career center to provide information on job announcements and searchable information on career and professional development seminars, workshops and conferences.

8. The system of claim 1, wherein the scientific community center comprises a conference center, the conference center including online forums, seminars, workshops and conferences in different scientific fields.

9. The system of claim 1, wherein the scientific community center comprises a collaborative center including opportunities to collaborate in scientific projects and clinical trials.

10. The system of claim 1, wherein the scientific community center comprises a global interactive center including opportunities to interact between different cultures and countries on joint scientific activities.
